(19) United States
(12) Patent Application Publication
(10) Pub. No.: US 2019/0344593 A1
(43) Pub. Date: Nov. 14, 2019

(54) PRINTING SYSTEM

(71) Applicant: Roland DG Corporation, Hamamatsu-shi (JP)

(72) Inventor: Yukinori KATSUNO, Hamamatsu-shi (JP)

(21) Appl. No.: 16/520,693

(22) Filed: Jul. 24, 2019

Related U.S. Application Data
(63) Continuation of application No. PCT/JP2018/001545, filed on Jan. 19, 2018.

(30) Foreign Application Priority Data
Jan. 25, 2017 (JP) 2017-010983

(51) Int. Cl. B41J 13/00; B41J 2/01; B41J 21/00; B41J 29/38; G06F 3/12; B41J 13/02; H04N 1/387; B65H 5/06

(52) U.S. Cl. CPC B41J 13/0009; B41J 2/01; B41J 21/00; B41J 29/38; B65H 5/06; G06F 3/1219; B41J 13/02; H04N 1/3877; H04N 1/3872; G06F 3/1208

(57) ABSTRACT

To prevent ink of printed images on a recording medium from adhering to pinch rollers, a computer determines whether or not a number of images aligned on a same plane by an image combiner are overlapping with a position of a position data representing positions of pinch rollers. As a result of this determination, when any of the images is overlapping with the position of the position data, the computer relocates these images on a same plane to prevent these images from overlapping with the position of the position data. Thereafter, the computer outputs a command to print the relocated images to a printer.

### CROSS REFERENCE TO RELATED APPLICATIONS

This application claims the benefit of priority to Japanese Patent Application No. 2017-010983 filed on Jan. 25, 2017 and is a Continuation Application of PCT Application No. PCT/JP2018/001545 filed on Jan. 19, 2018. The entire contents of each application are hereby incorporated herein by reference.

### BACKGROUND OF THE INVENTION

### 1. Field of the Invention

The present invention relates to printing systems including a printer and a computer.

### 2. Description of the Related Art

Some conventional printers have an imposition function of printing two or more images onto a single sheet of paper. A computer connected to such a printer accepts layouts of two or more images from a user and outputs a command to print these images to the printer. JP-A-2007-125726, JP-A-2000-127547, and JP-A-2009-302944 describe exemplified techniques of laying out images.

JP-A-5016716 discloses a serial-head inkjet printer. Specifically, heads mounted on a carriage reciprocate in the main scanning direction together with the carriage while a recording paper is fed by feeding means in the sub-scanning direction perpendicular to the main scanning direction. When the inks are squirted from the heads, an image is formed on the recording paper. The feeding means has a drive roller and a number of pinch rollers that are separated from one another and are arranged along the axial direction of the drive roller.

If the ink of images printed on the recording paper with the heads adhered to the pinch rollers, a degradation (blurring or missing color) of the images could occur.

### SUMMARY OF THE INVENTION

Preferred embodiments of the present invention prevent ink of printed images on a recording medium, such as a recording paper, from adhering to the pinch rollers.

According to a preferred embodiment of the present invention, a non-transitory computer-readable medium includes a program for causing a computer to cause a printer to perform printing, the printer including a drive roller, a pinch roller positioned to accommodate a recording medium between the drive roller and the pinch roller, and a head to squirt ink to the recording medium, the printer performs printing by feeding the recording medium by rotating the drive roller and squirting ink with the head, and the program causes the computer to define and function as: an image combiner to align two or more images on a same plane and combine the two or more images; a determiner to determine whether or not the images that have been combined by the image combiner are overlapping with a position of a position data representing a position of the pinch roller in a direction perpendicular or substantially perpendicular to a direction in which the recording medium is fed; a relocator to, when the determiner determines that any of the images that have been combined by the image combiner is overlapping with the position of the position data, cause the images to not overlap with the position of the position data by relocating the images that have been combined by the image combiner on a same plane and combine the images; and a print command generator to output a command to print the images relocated by the relocator to the printer.

Other features of preferred embodiments of the present invention will be apparent from the descriptions of the specification and drawings that follow.

Preferred embodiments of the present invention make it possible to reduce or prevent adhesion of the ink of printed images to the pinch rollers.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a printing system of a first preferred embodiment of the present invention.

FIG. 2 is a block diagram of the printing system of the first preferred embodiment of the present invention.

FIG. 3 is a diagram showing an alignment of images combined by a user.

FIG. 4 is a flowchart showing a sequence of operations of a computer in the printing system of the first preferred embodiment of the present invention.

FIG. 5 is a diagram for use in explaining that images combined by a user are not overlapping with a position represented by a position data.

FIG. 6 is a diagram for use in explaining that any of images combined by a user is overlapping with a position represented by a position data.

FIG. 7 is a diagram for use in explaining that images in landscape orientation shown in FIG. 6 are rotated 90 degrees.

FIG. 8 is a perspective view of a printing system of a second preferred embodiment of the present invention.

FIG. 9 is a block diagram of the printing system of the second preferred embodiment of the present invention.

FIG. 10 is a flowchart showing a sequence of operations of a computer in the printing system of the second preferred embodiment of the present invention.

FIG. 11 is a flowchart showing a sequence of operations of a computer in a printing system of a third preferred embodiment of the present invention.

### DETAILED DESCRIPTION OF THE PREFERRED EMBODIMENTS

### First Preferred Embodiment

Referring to the drawings, a first preferred embodiment of the present invention is described below. Preferred embodiments described below, however, include various limitations that are technically preferable for the purpose of implementing the present invention. The scope of the present invention is not limited to the following preferred embodiments and illustrated examples.

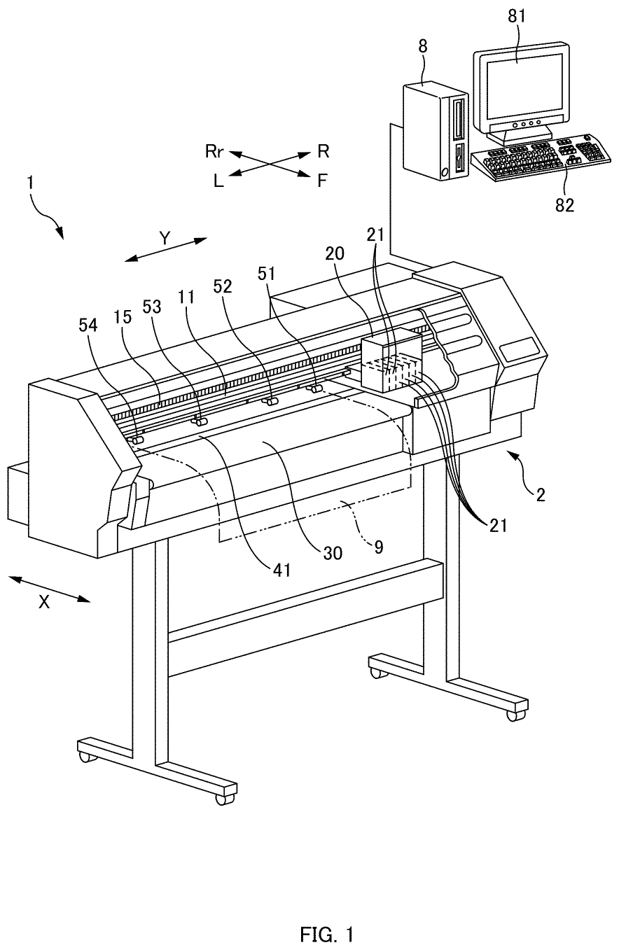

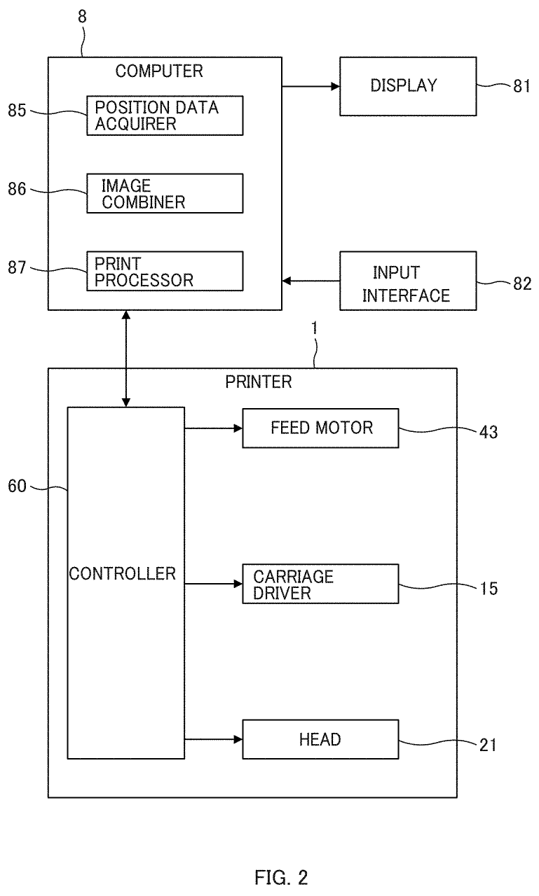

FIG. 1 is a perspective view of a printing system and FIG. 2 is a block diagram of the printing system. In FIG. 1, a printer 1 is shown with a portion of its main body 2 being removed. In the figures, the symbols F, Rr, L, and R denote front, rear, left, and right sides. In addition, the symbol Y denotes the main scanning direction (right-and-left direction) and the symbol X denotes the sub-scanning direction (front-and-back direction) perpendicular to the main scanning direction Y. The sub-scanning direction X corresponds to the direction in which a recording medium 9 is fed. The front corresponds to the upstream side, and the rear corresponds to the downstream side along the direction in which the recording medium 9 is fed.

This printing system includes the printer 1 and a computer 8.

The printer 1 produces printouts on the recording medium 9, which is made of resin, for example. The recording medium 9 is in the form of a sheet or web, and the recording medium 9 in the roll form is fed to the main body 2 of the printer 1. The recording medium 9 is not limited to being made of resin; instead, it may be made of, for example, paper, metal (e.g., metal foil) or a composite material (e.g., a laminated film of resin and metal layers).

The printer main body 2 preferably includes an onboard controller 60 that controls components of the printer 1. The controller 60 includes a control circuit including various driving circuits (such as a motor driver), a microcomputer and so forth. The controller 60 is connected to the computer 8 via a hardware interface and a transmission cable, for example.

A guide rail 11, a carriage driver 15, a platen 30, a drive roller (grid roller) 41, and pinch rollers 51 to 54 are attached to the frame of the printer main body 2.

The guide rail 11 extends in the main scanning direction Y. A carriage 20 is slidably mounted on the guide rail 11. The carriage 20 is guided by the guide rail 11 in the main scanning direction Y.

The carriage driver 15 is disposed along the guide rail 11. The carriage 20 is coupled to the carriage driver 15 and the carriage driver 15 moves the carriage 20 in the main scanning direction Y. The carriage driver 15 includes a motor and a power transmission (such as a belt transmission, a chain transmission, a ball-screw transmission, or a rack-and-pinion mechanism) that transmits the power of the motor, as the power of the carriage 20, to the carriage 20.

The carriage 20 includes a plurality of heads 21. The heads 21 are supplied with inks from ink tanks (not shown). Multiple nozzles are located beneath the heads 21, and the heads 21 squirt the inks downward from the nozzle. Certain heads are used to squirt process color (e.g., yellow, magenta, cyan, and black) inks as heads for process colors, and certain other heads 21 are used to squirt special inks (e.g., special color ink, white ink, transparent ink, and primer ink) that are not process color inks. Clear ink is colorless and transparent ink without any dye or pigment. In case the ink squirted from a head 21 is made of an ultraviolet-curable resin, an ultraviolet light source that projects light downward is mounted on the carriage 20 or an ultraviolet light source is attached, along the main scanning direction Y, to the frame of the printer main body 2 in front of the carriage 20 and above the platen 30 which will be described later.

The platen 30 is disposed under the guide rail 11, the carriage 20, and the heads 21. The recording medium 9 on the platen 30 is held by the platen 30. The upper surface of the platen 30 and the recording medium 9 face the lower surface of the heads 21.

A drive roller 41 is disposed under the carriage 20 and the heads 21 and behind the heads 21. Note that the drive roller 41 may be disposed ahead of the heads 21.

The drive roller 41 is attached to the frame of the printer main body 2 in such a way that the rotation axis of the drive roller 41 extends along the main scanning direction Y. A portion of the drive roller 41 is embedded in the platen 30 and an upper portion of the lateral surface of the drive roller 41 is exposed from the upper surface of the platen 30. The drive roller 41 is driven and rotated by a feed motor (drive machine) 43.

Above the drive roller 41, the pinch rollers 51 to 54 are disposed. The pinch rollers 51 to 54 are provided in such a way that they move vertically into contact with and away from the drive roller 41.

In addition, a driver (not shown) that drives the pinch rollers 51 to 54 upward and downward into contact with and away from the drive roller 41 is provided in the printer main body 2. With the pinch rollers 51 to 54 lowered by the driver, the recording medium 9 is held between the drive roller 41 and the pinch rollers 51 to 54. In this state, the pinch rollers 51 to 54 are pressed against the drive roller 41 with, for example, a spring. On the other hand, with the pinch rollers 51 to 54 lifted by the driver, the pinch rollers 51 to 54 are separated from the drive roller 41.

With the carriage driver 15, the heads 21, and the feed motor 43 described above being controlled by the controller 60, the printer 1 performs printing operation. The printing operation of the printer 1 is to perform a repeated cycle of feeding of the recording medium 9 by a certain distance by the feed motor 43 and moving the carriage 20 with squirting ink from the heads 21. Specifically, when the drive roller 41 is intermittently rotated and driven by the feed motor 43 with the pinch rollers 51 to 54 pressed against the drive roller 41 by the driver, the recording medium 9 held between the drive roller 41 and the pinch rollers 51 to 54 is intermittently fed forward by a certain distance. During each period of time in which the recording medium 9 is stopped, the carriage 20 is moved by the carriage driver 15 in the main scanning direction Y and the heads 21 squirt inks while the carriage 20 is moving.

This printer 1 performs a first printing operation, an operation to feed the recording medium 9 back, and a second printing operation in this order. During the first printing operation, the heads 21 for the process colors squirt inks, but the heads 21 for the special inks do not squirt any inks. In the operation to feed the recording medium 9 back, the recording medium 9 is fed backward until the area where the first printing operation had been made has passed backward under the heads 21 by the reverse turn of the drive roller 41; the reverse turn is performed by the feed motor 43 with the pinch rollers 51 to 54 pressed against the drive roller 41 by the driver. In the second printing operation, the heads 21 for the special inks squirt inks, but the heads 21 for the process colors do not squirt any inks. Therefore, the special inks squirted during the second printing operation are overlaid on the area subjected to the first printing. When the special ink is transparent, the area subjected to the first printing operation is coated with that transparent special ink, which enhances its glossiness. When the special ink is a special color ink or a white ink, a pattern with a special color or a white pattern is added on the area subjected to the first printing operation.

During the first printing operation, the heads 21 for the special inks may squirt inks (in particular, primer ink) and the heads 21 for the process colors may not squirt any inks. In this case, the heads 21 for the process colors squirt inks and the heads 21 for the special inks do not squirt any inks in the second printing operation.

The controller 60 stores position data representing positions of each of the pinch rollers 51 to 54 in the main scanning direction Y. The controller 60 transfers the stored position data to the computer 8 in response to a request from the computer 8.

A display (such as a liquid crystal display) 81 and an input interface (such as a keyboard, a pointing device, or a push button) 82 are connected to the computer 8. The computer 8 is a general-purpose personal computer 8 and includes a CPU, a RAM, a ROM, a GPU, a system bus, a hardware interface and so forth.

The computer 8 includes a built-in storage (such as a semiconductor memory or a hard disk drive) on which programs and various data are stored. The computer 8 is configured or programmed to define and function as a position data acquirer 85, an image combiner 86, and a print processor 87 by executing a program or programs stored on the storage.

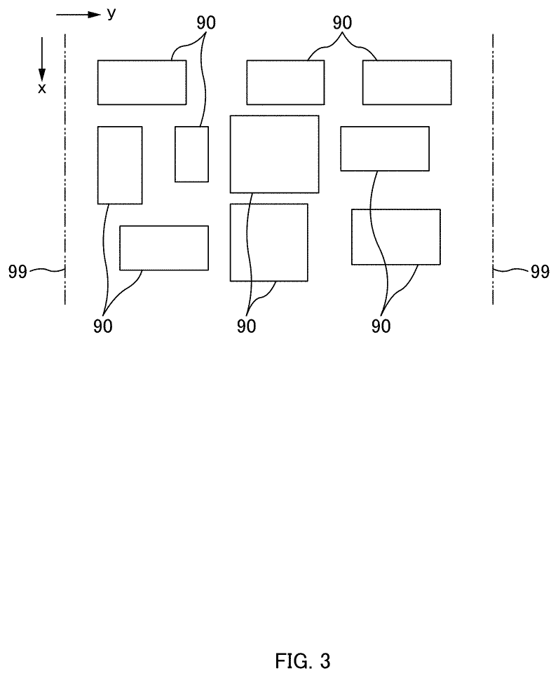

The image combiner 86 is configured or programmed to combine two or more images on a same xy plane. The term “combine” as used herein means uniting two or more image data into a single image data. Specifically, in response to a user's input made using the input interface 82 while viewing the display 81, the computer 8 reads the images stored on, for example, the storage and align images 90 on the xy plane with some gaps between them as shown in FIG. 3, according to the user input (a signal from the input interface 82). The xy plane herein is a virtual plane used to perform processing by the computer 8. The position of each point on the xy plane is represented by an ordered pair (an x-coordinate on a vertical line and a y-coordinate on a horizontal line). Therefore, when the user enters an ordered pair (x- and y-coordinates) of a reference point for an image 90 (e.g., a pixel at the upper left corner of the image 90) by operating the input interface 82, the corresponding image 90 is placed on the xy plane by the computer 8.

The horizontal direction (y-direction) and the vertical direction (x-direction) correspond to the main scanning direction Y and the sub-scanning direction X, respectively, on the xy plane. Sidelines 99 shown in FIG. 3 are parallel or substantially parallel to the x-axis and correspond to two side edges of the recording medium 9.

The position data acquirer 85 shown in FIG. 2 is configured or programmed to acquire and store the position data transferred from the controller 60 after requesting the position data from the controller 60. The position data represents the position of each of the pinch rollers 51 to 54 along the main scanning direction Y with a y-coordinate on the xy plane.

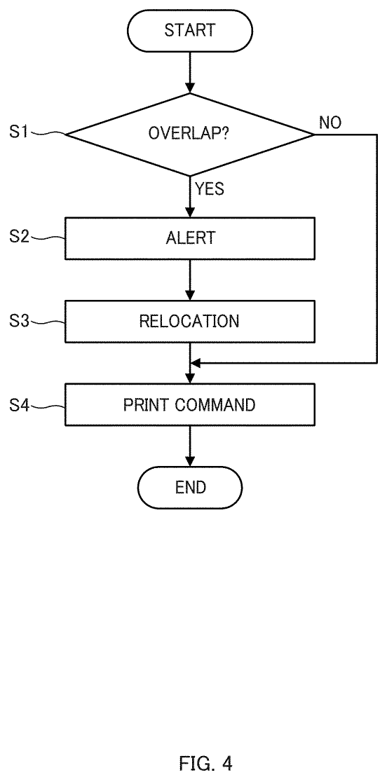

The print processor 87 is configured or programmed to respond to a user's input to perform printing entered by operating the input interface 82 after the images 90 that had been combined by the image combiner 86 have been aligned on the xy plane. Referring to FIG. 4, the function of the print processor 87, i.e., a sequence of operations performed by the computer 8 when the user enters an input to perform printing, is described in detail below.

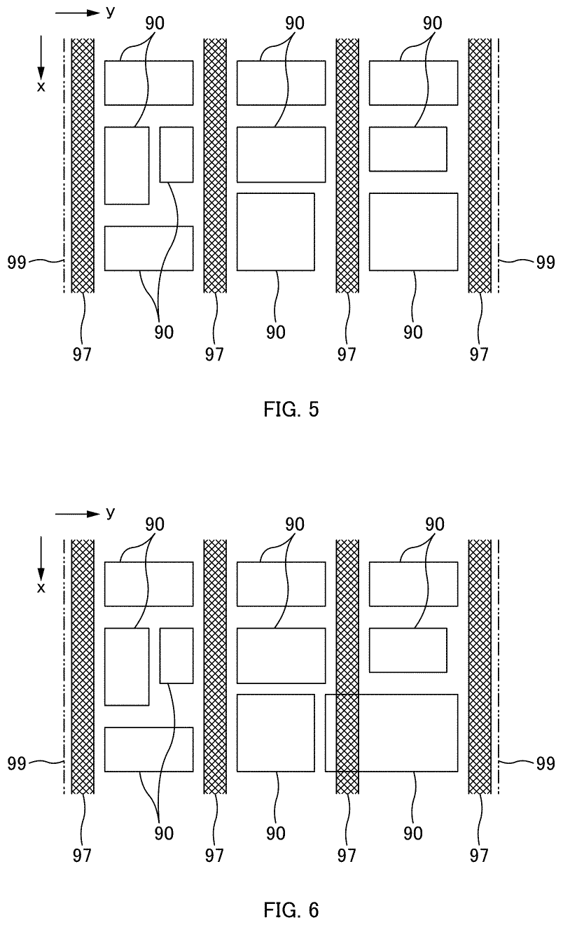

First, the computer 8 determines whether or not the images 90 that have been combined by the image combiner 86 are overlapping with positions represented by the position data (i.e., the positions of the pinch rollers 51 to 54) acquired by the position data acquirer 85 (step S1). Specifically, the computer 8 determines horizontal spans of the images 90 as y-coordinates based on the respective y-coordinates of their reference points and their widths and compares the horizontal spans of the images 90 with the position data. When a value of the position data is out of the horizontal spans of all images 90, then all images 90 are not overlapping with positions 97 represented by the position data as shown in FIG. 5. When the value of the position data is within a horizontal span of any of the images 90, then that image 90 is overlapping with a position 97 represented by the position data as shown in FIG. 6.

When the result of the determination made at the step S1 indicates that one or more images 90 are overlapping with one or more positions 97 represented by the position data, the processing performed by the computer 8 proceeds to step S2. On the other hand, when no image 90 is overlapping with the positions 97 represented by the position data, the processing performed by the computer 8 proceeds to step S4.

At the step S2, the computer 8 produces a denotation indicating an alert and outputs a video signal based on that denotation to the display 81. In response to this, the denotation indicating an alert is displayed on the display 81. The computer 8 may produce a sound indicating an alert and output a sound signal based on that sound to a speaker. In response to this, a user is aware of misalignment of the images 90. The misalignment of the images 90 as used herein refers to a situation where a printed image comes into contact with the one or more pinch rollers 51 to if printing is performed without any remedy against such misalignment.

Subsequently, the processing of the computer 8 proceeds to step S3.

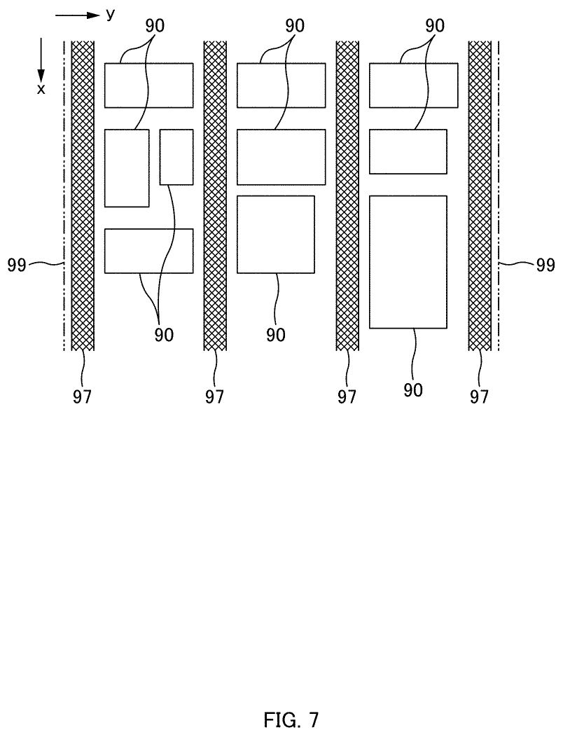

At the step S3, the computer 8 realigns the images 90 that have been combined by the image combiner 86 on the same xy plane and combines these images 90. To do so, the computer 8 refers to the width of each image 90 and determines the x- and y-coordinates of the reference point of each image 90 in such a way that the image 90 does not overlap with the positions 97 represented by the position data acquired by the position data acquirer 85. In addition, as shown in FIG. 6 as an example, when an image 90 that is overlapping with a position 97 represented by the position data is in landscape orientation, the computer 8 rotates, 90 degrees, that image 90 and then places that image 90 on the xy plane as shown in FIG. 7. The computer 8 determines the x- and y-coordinates of the reference point of each image 90 in such a way that an x-directional range in which a number of images 90 are included is optimized to be minimum.

Subsequently, the processing performed by the computer 8 proceeds to the step S4.

When the processing performed by the computer 8 proceeds from the step S3 to the step S4, the computer 8 produces a group of command codes for printing based on the images 90 that have been combined by the processing at the step S3. On the other hand, when the processing performed by the computer 8 proceeds from the step S1 to the step S4, the computer 8 produces a group of command codes for printing based on the images 90 that have been combined by the image combiner 86.

The group of print command codes is similar to those used for typical serial printers. The computer 8 transfers the group of print command codes to the controller 60. This completes the print processing by the computer 8.

When the group of print command codes has been transferred to the controller 60, the controller 60 controls the carriage driver 15, the heads 21, and the feed motor 43 according to the group of print command codes. As a result, the printer 1 performs printing operations. That is, the formation of a piece of image on the recording medium 9 with the heads 21 squirting the inks while the carriage 20 is moving in the scanning direction alternates with the feeding of the recording medium 9 by a certain distance by the rotation of the drive roller 41 by a certain angle. As described above, the first printing operation, the feed-back operation, and the second printing operation are performed in this order

In the aforementioned preferred embodiment, a number of images 90 are automatically relocated by the computation by the computer 8 at the step S3, but the processing performed by the computer 8 may be terminated at the step S3. In this case, a user can relocate the images 90 by operating the input interface 82 by the image combiner 86.

When the images 90 have been misaligned by a user (see FIG. 6), these images 90 are relocated at the step S3. Thus, the ink of the printed images on the recording medium 9 does not adhere to the pinch rollers 51 to 54. Therefore, clear, high-quality printing is achieved.

When the images 90 have been misaligned by a user, he will be aware of that misalignment by the alert (see the step S4). Therefore, the user can take a certain measure to prevent the ink of the printed images on the recording medium 9 from adhering to the pinch rollers 51 to 54.

### Second Preferred Embodiment

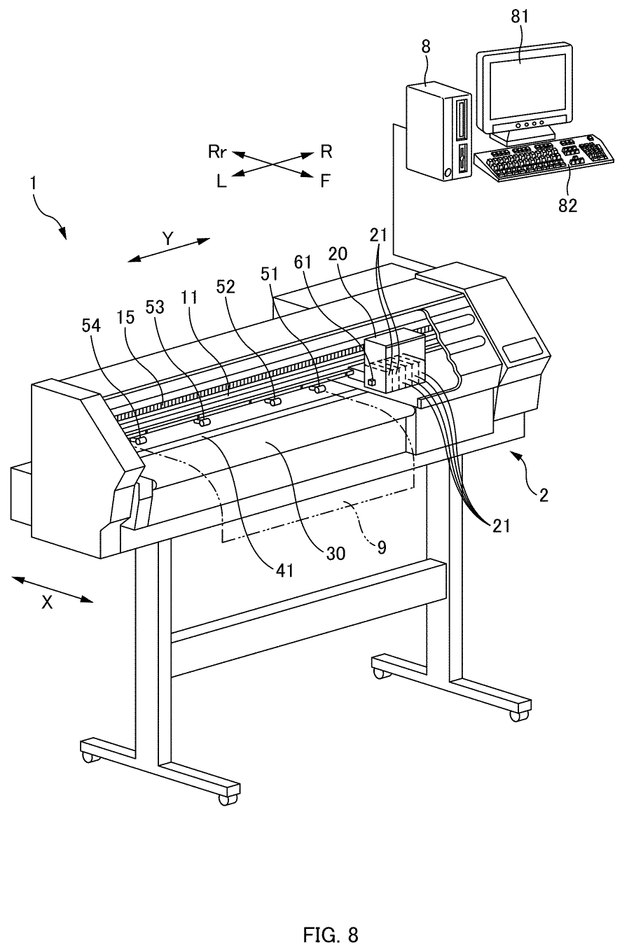

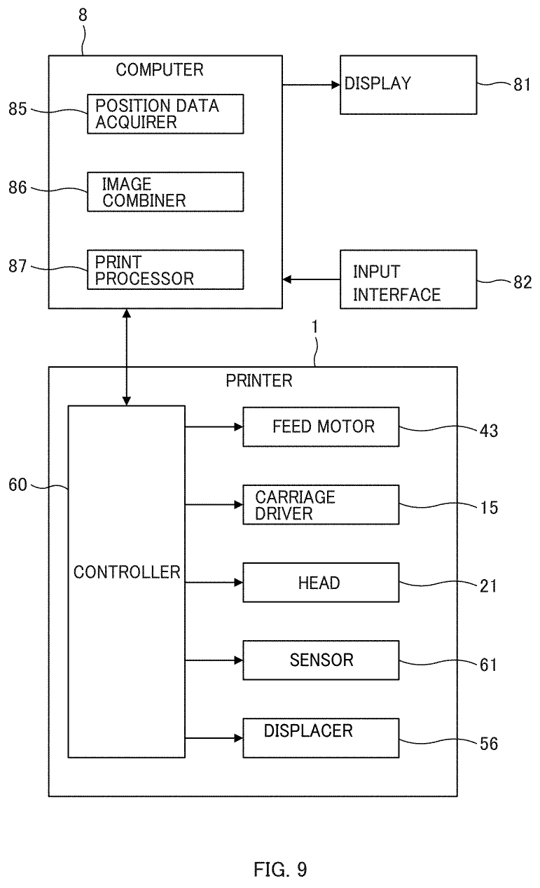

Next, referring to FIGS. 8 to 10, a second preferred embodiment of the present invention is described. The components of the printing system of the second preferred embodiment which correspond to those of the printing system of the first preferred embodiment are denoted by the like reference numerals. In addition, the following description mainly focuses on the difference between the printing systems of the second and first preferred embodiments.

In the first preferred embodiment, the positions of the pinch rollers 51 to 54 in the main scanning direction Y are fixed. In the second preferred embodiment, the pinch rollers 51 to 54 are movable in the main scanning direction Y by a guide rail and so on. The pinch rollers 51 to 54 are moved in the main scanning direction Y by a displacement mechanism 56 including a motor and other components. The displacement mechanism 56 is controlled by the controller 60.

In addition, a sensor (such as a photosensor including of a light projector and a light receiver, a limit switch, or a touch sensor) 61 that detects the pinch rollers 51 to 54 are disposed on the carriage 20 and outputs of the sensor 61 are outputted to the controller 60. Here, the carriage 20 moves in the main scanning direction Y as a result of the servo-control of the carriage driver 15 by the controller 60 in response to a request from the computer 8 (the position data acquirer 85). The position of the carriage 20 at the time when the output of the sensor 61 has changed is recognized by the controller 60 as the positions of the pinch rollers 51 to 54. This function corresponds to the position detector. The controller 60 stores the recognized positions of the pinch rollers 51 and 54 as a position data. The controller 60 transfers, in response to a request from the computer 8 (the position data acquirer 85), the stored position data to the computer 8.

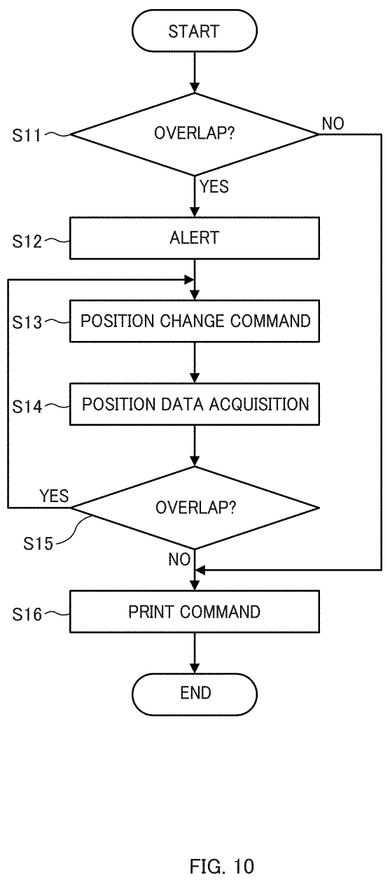

Furthermore, the position data acquirer 85 and the image combiner 86 of the computer 8 in the second preferred embodiment are identical to those described in the first preferred embodiment. However, the print processor 87 of the computer 8 in the second preferred embodiment is different from that described in the first preferred embodiment. Thus, a function of the print processor 87 in the second preferred embodiment, i.e., a sequence of operations performed by the computer 8 when a user enters an input to perform printing is described in detail with reference to FIG. 10.

Operations at steps S11 and S12 are identical to those at the steps S1 and S2, respectively, described in the first preferred embodiment. Note that when the result of the determination made at the step S11 indicates that no image 90 is overlapping with the positions 97 represented by the position data (see FIG. 5), the processing performed by the computer 8 proceeds to step S16. On the other hand, when one or more images 90 are overlapping with one or more positions 97 represented by the position data (see FIG. 6), the processing performed by the computer 8 proceeds to the step S12.

At the next step S13, the computer 8 issues a command to change the positions of the pinch rollers 51 to 54 to the controller 60. Then, the controller 60 controls the displacement mechanism 56 according to the command from the computer 8 and the pinch rollers 51 to 54 are moved in the main scanning direction Y. As a result of this, the positions of the pinch rollers 51 to 54 are changed.

At the next step S14, the computer 8 requests the position data from the controller 60. The carriage 20 moves in the main scanning direction Y as a result of the servo-control of the carriage driver 15 by the controller 60 that has accepted the request for the position data. The position of the carriage 20 at the time when the output of the sensor 61 has changed is recognized by the controller 60 as the positions of the pinch rollers 51 to 54. The controller 60 transfers, to the computer 8, the recognized positions of the pinch rollers 51 to 54 as a position data. Then, the computer 8 acquires the position data that has been transferred from the controller 60.

At the next step S15, the computer 8 determines whether or not the images 90 that have been combined by the image combiner 86 are overlapping with the positions represented by the position data (i.e., the positions of the pinch rollers 51 to 54) acquired at the step S14. This operation is similar to that performed at the step S11; provided that since the positions of the pinch rollers 51 to 54 have been changed at the step S13, the position data referred to at the step S15 may be different from the position data referred to at the step S11.

When the result of the determination made at the step S15 indicates that one or more images 90 are overlapping with the positions represented by the position data acquired at the step S14, the processing performed by the computer 8 returns to the step S13. On the other hand, when no image 90 is overlapping with the position represented by the position data acquired at the step S14, the processing performed by the computer 8 proceeds to the step S16.

At the step S16, the computer 8 produces a group of command codes for printing based on the images that have been combined by the image combiner 86. The group of print command codes is similar to those used for typical serial printers. The computer 8 transfers the group of print command codes to the controller 60. This completes the print processing by the computer 8.

In this preferred embodiment, when the images 90 have been misaligned by a user (see FIG. 6), the positions of the pinch rollers 51 to 54 are changed (see the steps S13 to S15) and thus the ink of the printed images on the recording medium 9 does not adhere to the pinch rollers 51 to 54. Therefore, clear, high-quality printing is achieved.

### Third Preferred Embodiment

Next, referring to FIGS. 8, 9, and 11, a third preferred embodiment of the present invention is described. The components of the printing system of the third preferred embodiment which correspond to those of the printing system of the second preferred embodiment are denoted by the like reference numerals. In addition, the following description mainly focuses on the difference between the printing systems of the third and second preferred embodiments.

The printer 1 in the third preferred embodiment is configured in a similar manner as that in the second preferred embodiment.

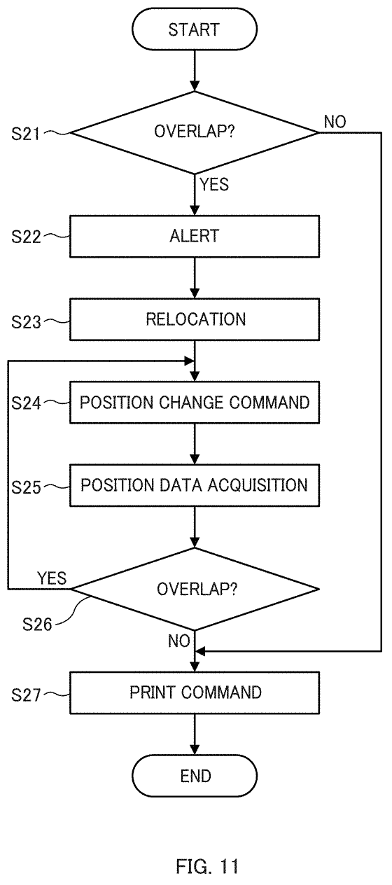

Furthermore, the position data acquirer 85 and the image combiner 86 of the computer 8 in the third preferred embodiment are identical to those described in the first and second preferred embodiments. However, the print processor 87 of the computer 8 in the third preferred embodiment is different from those described in the first and second preferred embodiments. Thus, a function of the print processor 87 in the third preferred embodiment, i.e., a sequence of operations performed by the computer 8 when a user enters an input to perform printing is described in detail with reference to FIG. 11.

Operations at steps S21 and S22 are identical to those at the steps S11 and S12, respectively, described in the first preferred embodiment. Note that when the result of the determination made at the step S21 indicates that no image 90 is overlapping with the positions 97 represented by the position data (see FIG. 5), the processing performed by the computer 8 proceeds to step S27. On the other hand, when one or more images 90 are overlapping with one or more positions 97 represented by the position data (see FIG. 6), the processing performed by the computer 8 proceeds to the step S22.

At step S23, the computer 8 realigns the images 90 that have been combined by the image combiner 86 on the same xy plane and combines these images 90. Upon realignment of the images, the computer 8 produces, on the xy plane, an area that is longer in the vertical direction (x-direction) in which no image is arranged.

At the next step S24, the computer 8 issues a command to change the positions of the pinch rollers 51 to 54 to the controller 60. Then, the controller 60 controls the displacement mechanism 56 according to the command from the computer 8 and the pinch rollers 51 to 54 are moved in the main scanning direction Y. As a result of this, the positions of the pinch rollers 51 to 54 are changed.

At the next step S25, the computer 8 request the position data from the controller 60. The carriage 20 moves in the main scanning direction Y as a result of the servo-control of the carriage driver 15 by the controller 60 that has accepted the request for the position data. The position of the carriage 20 at the time when the output of the sensor 61 has changed is recognized by the controller 60 as the positions of the pinch rollers 51 to 54. The controller 60 transfers, to the computer 8, the recognized positions of the pinch rollers 51 to 54 as a position data. Then, the computer 8 acquires the position data that has been transferred from the controller 60.

At the next step S26, the computer 8 determines whether or not the images 90 that have been relocated at the step S23 are overlapping with the images represented by the position data (i.e., the positions of the pinch rollers 51 to 54) acquired at the step S25. This operation is similar to that described in terms of the step S21.

When the result of the determination made at the step S26 indicates that one or more images 90 are overlapping with the positions represented by the position data, the processing performed by the computer 8 returns to the step S24. On the other hand, when no image 90 is overlapping with the position represented by the position data, the processing performed by the computer 8 proceeds to the step S27.

When the processing performed by the computer 8 proceeds from the step S26 to the step S27, the computer 8 produces a group of command codes for printing based on the images that have been combined by the processing at the step S23. On the other hand, when the processing performed by the computer 8 proceeds from the step S21 to the step S27, the computer 8 produces a group of command codes for printing based on the images 90 that have been combined by the image combiner 86. The group of print command codes is similar to those used for typical serial printers. The computer 8 transfers the group of print command codes to the controller 60. This completes the print processing by the computer 8.

In this preferred embodiment, when the images 90 have been misaligned by a user (see FIG. 6), the images 90 are relocated (see the step S23) and the positions of the pinch rollers 51 to 54 are changed (see the steps S24 to S26) and thus the ink of the printed images on the recording medium 9 does not adhere to the pinch rollers 51 to 54. Therefore, clear, high-quality printing is achieved.

The preferred embodiments for implementing the present invention have thus been described, these descriptions of the preferred embodiments are made for the purpose of facilitating the understanding of the present invention and do not intend to limit the interpretation of the present invention. Further, various changes, modifications and improvements can be made without departing from the spirit and scope of the present invention and the present invention also includes equivalents thereof. Some changes from the above-mentioned preferred embodiments are described below. These changes may be applied in combination as much as possible.

The printer 1, which is a serial-head (scanning type) ink jet printer in the above-mentioned preferred embodiments, may be a line-head ink jet printer. Specifically, the guide rail 11, the carriage 20, and the carriage driver 15 are not provided, and the heads 21 are attached to the frame of the printer main body 2 and extends in the main scanning direction Y above the platen 30. In this case, the recording medium 9 may be fed continuously during the printing operation of the printer 1.

A cutter which is moved up and down by a solenoid may be mounted on the carriage 20. In this case, the printer 1 performs cutting instead of the second printing operation. During cutting, the controller 60 controls a solenoid, the carriage driver 15, and the feed motor 43 and the cutter lowered by the solenoid moves in the right-and-left direction (the main scanning direction Y). The recording medium 9 is thus fed in the front-and-back direction (the sub-scanning direction X). This results in the production of a cutting line of a certain shape (e.g., a box-shape enclosing a print image) on the recording medium 9.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printing system comprising:
a printer including a drive roller, a pinch roller positioned to accommodate a recording medium between the drive roller and the pinch roller, and a head to squirt ink to the recording medium, the printer performing printing by feeding the recording medium by rotation of the drive roller and squirting ink with the head; and
a computer to command the printer to perform printing, the computer being configured or programmed to include:
an image combiner to align two or more images on a same plane and to combine the two or more images;
a determiner to determine whether or not the two or more images that have been combined by the image combiner are overlapping with a position of a position data representing a position of the pinch roller in a direction perpendicular or substantially perpendicular to a direction in which the recording medium is fed;
a relocator to, when the determiner determines that any of the two or more images that have been combined by the image combiner is overlapping with the position of the position data, cause the two or more images not to overlap with the position of the position data by relocating the two or more images that have been combined by the image combiner on a same plane and combine the two or more images; and
a print command generator to output to the printer a command to print the two or more images relocated by the relocator.

2. A printing system comprising:
a printer including a drive roller, a pinch roller positioned to accommodate a recording medium between the drive roller and the pinch roller, and a head to squirt ink to the recording medium, the printer performing printing by feeding the recording medium by rotation of the drive roller and squirting ink with the head; and
a computer to command the printer to perform printing, the computer being configured or programmed to include:
an image combiner to align two or more images on a same plane and to combine the two or more images;
a determiner to determine whether or not the two or more images that have been combined by the image combiner are overlapping with a position of a position data representing a position of the pinch roller in a direction perpendicular or substantially perpendicular to a direction in which the recording medium is fed; and
an alert processor to, when the determiner determines that any of the two or more images that have been combined by the image combiner are overlapping with the position of the position data, perform alert processing to provide an alert.

3. A printing system comprising:
a printer including a drive roller, a pinch roller positioned to accommodate a recording medium between the drive roller and the pinch roller, and a head to squirt ink to the recording medium, a displacer to displace the pinch roller in an axial direction of the drive roller, and a position detector to detect a position of the pinch roller in an axial direction of the drive roller, the printer performing printing by feeding the recording medium by rotation of the drive roller and squirting ink with the head; and
a computer to command the printer to perform printing, the computer being configured or programmed to include:
an image combiner to align two or more images on a same plane and to combine the two or more images;
a determiner to determine whether or not the two or more images that have been combined by the image combiner are overlapping with a position detected by the position detector; and
a displacement command generator to, when the determiner determines that any of the two or more images that have been combined by the image combiner is overlapping with the position detected by the position detector, output to the printer a command to cause the displacer to displace the pinch roller.

4. The printing system according to claim 3, wherein
the computer repeatedly performs functions of the displacement command generator and the determiner until the determiner determines all images that have been combined by the image combiner are not overlapping with the position detected by the position detector; and
the computer is configured or programmed to include a print command generator to output a command to the printer to print the images that have been combined by the image combiner when the determiner determines that all images that have been combined by the image combiner are not overlapping with the position detected by the position detector.
